(19) United States
(12) Patent Application Publication
(10) Pub. No.: US 2011/0088978 A1
(43) Pub. Date: Apr. 21, 2011

(54) Platform elevator

(76) Inventors: Pierre Tremblay, Chertsey (CA); Jean-François Ducharme, Montreal (CA)

(21) Appl. No.: 12/805,683

(22) Filed: Aug. 13, 2010

(30) Foreign Application Priority Data
Aug. 14, 2009 (CA) 2,676,579

(51) Int. Cl. B66F 7/02

(52) U.S. Cl. 187/210; 187/203

(57) ABSTRACT

There is provided a compact cantilever platform elevator for lifting and storing goods such as small vehicles overheads for space saving. The platform elevator comprises i) an upright frame having first and second elongated upright members provided with a longitudinal track and an elongated generally orthogonal leg at their lower end, and connected to each other at an upper end thereof by an elongated hoisting box having an axial rotatable shaft for driving first and second hoisting assemblies having respectively a first and a second slender hoisting member extending from a lower end thereof and vertically movable in response to rotation of the shaft, and ii) a cantilever platform connected to the hoisting members and comprising a generally horizontal supporting surface and first and second lateral upright runners adapted to snugly glide in respective first and second tracks of the upright members. Thereby, rotation of the shaft causes the platform to be upwardly or downwardly translated smoothly while being guided by the runners traveling in the tracks. According to specific embodiments, the hoisting members may comprise chains, belts and/or cables, and the hoisting assemblies may comprise chain blocks, sprockets and/or winding hubs.

### CROSS REFERENCE TO RELATED APPLICATION

### Priority Statement Under 35 U.S.C. S.119(e) & 37 C.F.R. S.1.78

This non-provisional patent application claims priority based upon the prior CANADIAN patent application entitled “PLATFORM ELEVATOR”, application No. 2,676,579, filed Aug. 14, 2009, in the name of TREMBLAY, Pierre.

### FIELD OF THE INVENTION

The present invention generally relates to apparatuses for lifting charges such as light vehicles. More specifically, but not exclusively, the present invention is concerned with a platform elevator enabling lifting and storage of a load such as a light vehicle stored at a higher level while other material such as a second light vehicle may be stored underneath. The elevator structure may further enable vehicle lifting to facilitate mechanical work to be carried out on lower parts of the vehicle.

### BACKGROUND OF THE INVENTION

In many circumstances, it is desired to provide a storage rack to store material at different heights in order to make more efficient use of floor space and room volume. However, that raises the need for material handling means for lifting material to upper levels. An increasing need relates to small sport vehicle owners seeking space to store their vehicles such as motorcycles, snowmobiles, ATV's, etc when not in use, especially in off seasons, for more or less extended time periods. Therefore, there is a need for a compact and low cost apparatus enabling overhead storage of such vehicles in a small room such as a dwelling garage, without requiring additional costly and cumbersome material handling means.

Many types of elevating platforms have been provided in the prior art for multi-tier parking applications or vehicle repair shops. However, they offer excessive capacity, are generally powered by expensive high power hydraulic or electric motor systems require special power supplies and are prohibitive both in size and cost for the needs of most small vehicles owners. Therefore, it would be desirable to provide a compact and low cost platform elevator that could be used to lift and store small vehicles in height, thereby freeing floor space to store another vehicle or other material.

An object of the present invention is therefore to provide a platform elevator which obviates the limitations and drawbacks of the prior art lifting and storage apparatuses and systems.

### SUMMARY OF THE INVENTION

More specifically, in accordance with the present disclosure, there is broadly provided a platform elevator comprising i) an upright frame having first and second elongated upright members provided with a longitudinal track and an elongated generally orthogonal leg at their lower end, and connected to each other at an upper end thereof by an elongated hoisting box having an axial rotatable shaft for driving first and second hoisting assemblies having respectively a first and a second slender hoisting member extending from a lower end thereof and vertically movable in response to rotation of the shaft, and ii) a cantilever platform connected to the hoisting members and comprising a generally horizontal supporting surface and first and second lateral upright runners adapted to snugly glide in respective first and second tracks of the upright members, whereby, rotation of the shaft causes the platform to be upwardly or downwardly translated while being guided by the runners traveling in the tracks.

According to an aspect of the platform elevator, the first hoisting member may be connected to a top portion of the first runner and the second hoisting member may be connected to a top portion of the second runner.

According to another aspect of the platform elevator, the first hoisting assembly may comprise a first winding hub mounted to a first end portion of the shaft and said second hoisting assembly may comprise a second winding hub mounted to a second end portion of the shaft, so that the first and second winding hubs be synchronously rotatable through shaft rotation. The winding hubs may comprise a drum or a spool. The drum may have a frustoconical or cylindrical shape.

According to another aspect of the elevator, the flexible slender hoisting member may comprise a circular cross-section cable made of metallic or plastic material. According to another aspect, the flexible hoisting member may comprise a flat belt made of plastic material cooperating with a winding spool to wind in a single width pile winding.

According to a further aspect of the platform elevator, the hoisting box may further comprise a compensating coil spring assembled to the shaft for partly counterbalancing platform weight and a load supported thereby.

According to another aspect of the platform elevator, the shaft may be provided with a sprocket mounted at an end thereof projecting out of the hoisting box and be connected to a gear box through an endless belt or chain and driven thereby. The gearbox may be connected to a rotating handle (crank) or to an electric motor. The gearbox may comprise a ratcheting device to prevent accidental unwinding. The shaft sprocket may also be rotated directly by a hand pulled endless chain engaged on the shaft driving sprocket.

According to another aspect, each track may define first and second axial rails and each runner may define a first roller projecting from a first side of the runner to travel on the first rail and a second roller vertically spaced from the first roller, projecting from a second opposite side of the runner to travel on the second rail, so that opposite horizontal reaction forces proportional to the vertical spacing between the rollers are applied on said first and second rails to counterbalance a torque created by the cantilever platform and a load supported thereon, thus maintaining said platform in a stable horizontal attitude in any vertical position.

According to an aspect of the platform elevator, the first hoisting assembly may comprise a first chain sprocket mounted to a first end portion of the shaft and said second hoisting assembly may comprise a second chain sprocket mounted to a second end portion of the shaft, first and second sprockets being synchronously drivable through shaft rotation.

According to a further aspect of the platform elevator, i) the first hoisting assembly may comprise a chain block having a housing rigidly mounted to said first upright member, an input sprocket driven by said shaft through said first sprocket and an endless chain, and an output sprocket driving one of the at least one hoisting member extending from said first hoisting assembly and connected to a first end of the cantilever platform and, ii) the second hoisting assembly may comprise a chain block having a housing rigidly mounted to said second upright member, an input sprocket driven by the shaft through said second sprocket and an endless chain, and an output sprocket driving one of the at least one hoisting member extending from said second hoisting assembly and connected to a second end of the cantilever platform.

Usable chain blocks typically comprise internal gearing providing speed reduction between the output sprocket and the input sprocket so that a load generating a torque on said output sprocket can be counterbalanced by a lower torque applied to the shaft. Chain blocks would further comprise an internal braking device for maintaining the vertical position of the cantilever platform while no torque is applied to the shaft.

According to another aspect of the invention, the platform may further comprise a safety break device cooperating with at least one track and the associated runner to prevent relative movement especially for long storage periods. The runners may further be provided with pairs of rollers running on inner sides of the tracks and a slippery material pad for gliding on a back face of the tracks.

The foregoing and other objects, advantages and features of the present invention will become more apparent upon reading of the following non-restrictive description of an illustrative embodiment thereof, given by way of example only with reference to the accompanying drawings.

### BRIEF DESCRIPTION OF THE DRAWINGS

Similar parts are identified by identical or similar numbers throughout the drawings. In the appended drawings:

FIG. 1 is an isometric view of a platform elevator according to an embodiment of the present invention;

FIG. 2 is a front elevational view of the platform elevator of FIG. 1;

FIG. 3 is a top view of the platform elevator of FIG. 1;

FIG. 4 is a partial schematic side elevational view of the platform elevator of FIG. 1;

FIGS. 5a and 5b are schematic representations of a safety brake according to the invention, respectively shown in an engaged and in a disengaged position.

FIG. 6a is a side elevational view of the platform elevator according to an alternate embodiment implementing a chain drive hoisting assembly mechanism;

FIG. 6b is a front elevational view as seen from line A-A of FIG. 6a.

FIG. 6c is an enlarged view of the left hand portion of the elevator of FIG. 6b, to show details of the chain drive hoisting assembly mechanism.

### DETAILED DESCRIPTION

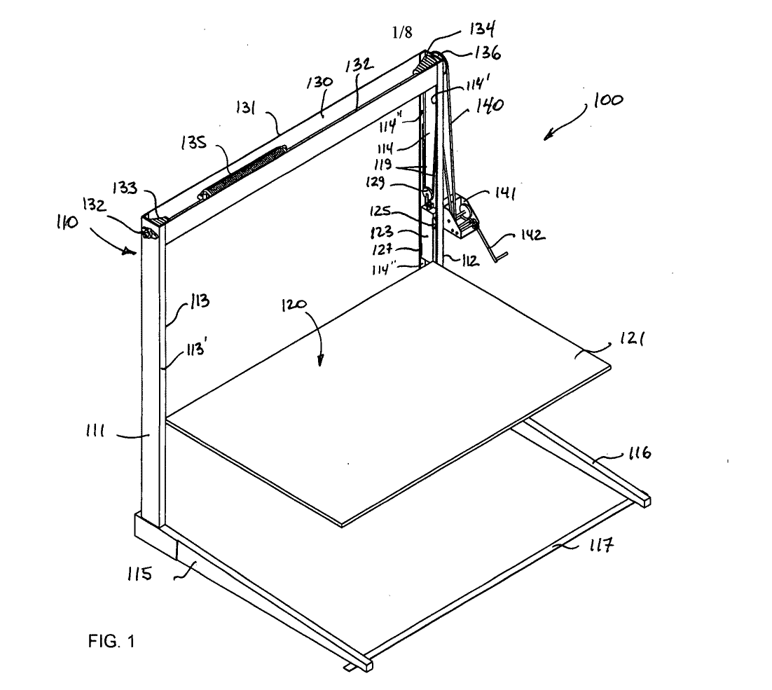

Referring to FIGS. 1 to 4, the non-restrictive illustrative embodiment of the present invention is basically concerned with a platform elevator 100 for the lifting and overhead storage of light vehicles or material.

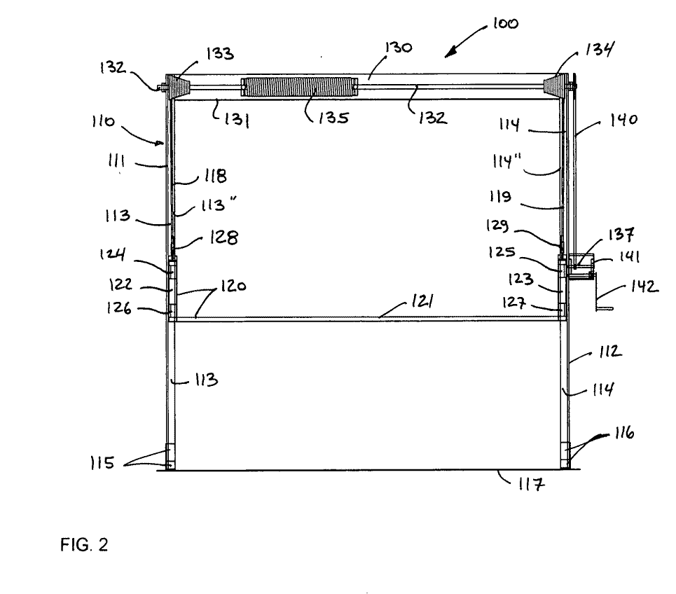

The platform elevator 100 basically comprises an upright frame 110 having first and second elongated upright members 111, 112, each comprising a U shape longitudinal guiding track 113, 114 (see FIG. 2) and an elongated generally orthogonal leg 115, 116 at its lower end, said upright members being connected to each other at an upper end thereof by an elongated hoisting box 130. Legs 115, 116 may advantageously be connected to each other by a rigid tie member 117 to prevent lateral movement of the legs and improve stability. The elevator 100 further comprises a cantilever low-profile platform 120 comprising a generally horizontal supporting surface 121 and first and second lateral upright runners 122, 123 adapted to glide respectively in tracks 113, 114 of upright members 111 and 112 to provide a vertically translatable cantilever support of the platform 120.

Each U shape track 113, 114 can be made from an aluminum extruded channel and defines a pair of flanges providing parallel vertical flat rails 113′, 113″ and 114′, 114″, the rails in a pair facing each other. Each runner 122, 123 is provided with an upper roller 124, 125 on one side and a lower roller 126, 127 on the opposite side, each roller of a given runner running on one of the facing rails of a given track. For example, runner 123 has upper roller 125 running on rail 114′ and lower roller 127 running on rail 114″ of track 114. The weight of the cantilever platform 120 generates a torque in runners 122, 123 which is compensated by each roller being kept in compression against its corresponding rail to maintain the supporting surface 121 perpendicular to upright members 111, 112 and provide a vertically translatable platform assembly 120. The vertical spacing between upper and lower roller is critical as it determines the reaction forces between the roller and the rails, which could cause jamming or instability if such forces are too high or too low with respect to the rollers and rails specifications. Each runner 122, 123 is further provided with a free rolling pulley 128, 129 mounted on top of it to provide a lifting point as part of a tickle pulling assembly. The runners may further comprise a backing slippery material to control friction and wear between the back of the runners and the back wall of the U shape tracks. A pad of self lubricating material such as Nylon®, Delrin®, polyethylene, etc. can be used to that effect.

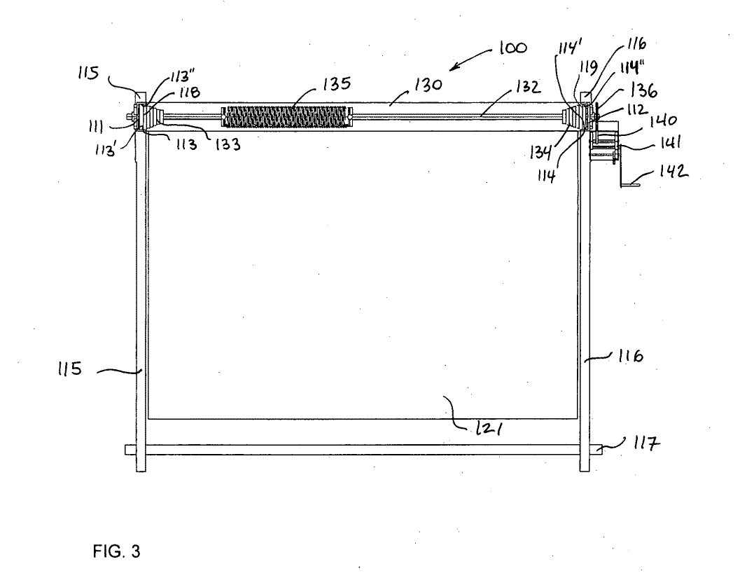

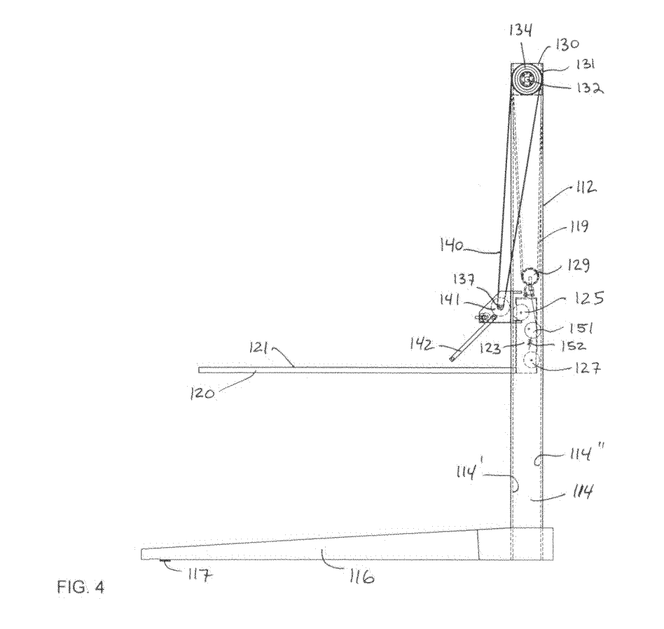

Referring mainly to the embodiment illustrated in FIGS. 3 and 4, upward and downward translation of the platform 120 is performed through a hoisting assembly comprising the hoisting box 130, slender hoisting members i.e. ropes 118, 119, (cables or belts) extending downwardly therefrom, and a rotation generation and transmission assembly. In the illustrated embodiment of the invention, ropes 118, 119 comprise steel cables cooperating respectively with pulleys 128 and 129 to form two symmetrical tackles, each cable having an extremity attached to a top portion of the frame 110, running downwardly through the corresponding pulley on top of the runner and running back upwardly to wind on a winding means in hoisting box 130. Thereby, the winding force in each cable is one quarter of the combined weight of the platform 120 and carried load, which advantageously reduces the required power and strength of the hoisting assembly components. Since a payload of about one thousand pounds is considered for the contemplated applications, relatively light and inexpensive components may be selected.

As best seen from the top view of FIG. 3, the hoisting box 130 comprises a frame 131 and a hoisting assembly mounted thereto comprising a shaft 132 rotatably mounted to the frame, a first frustoconical drum (hub or spool) 133 (winding device) assembled at an end of the shaft 132 to wind cable 118, a second frustoconical drum 134 assembled at the opposite end of shaft 132 to wind cable 119, a tubular coil spring 135 traversed by the shaft 132 and having an extremity attached thereto and a second extremity attached to the frame 131, and a sprocket 136 mounted to a free end of the shaft 132 extending from the box 130.

Imparting a rotation motion to the sprocket 136 thereby causes the shaft and drums to rotate thus winding or unwinding cables 118 and 119 on the drums 133 and 134 to lift or lower the platform 120 according to the direction of rotation. The elongated compensation coil spring 135 is biased to supply a counterbalancing force which approximately neutralizes the effect of the weight of the platform 120 when it is near to its lowest position and its compensation torque gradually diminishes as it unwinds when lifting of the platform 120 is performed. The cables 118, 119 are winding from the larger to the smaller diameter portion of the drums 133, 134 to gradually decrease the torque applied to the shaft by the tensioned cables as the spring compensation is reduced.

According to an aspect of the invention, cables 118, 119 may be replaced by flat belts made of tough material such as Nylon® winding on spools or directly on the shaft 132 in a narrow, single width pile multi-turn winding. In such a case, the winding diameter increases during the lifting operation which slightly increases the torque applied to the shaft by the belts but accelerates the lift per turn ratio. This effect may be partly compensated by selecting a longer coil spring 135 featuring an improved linearity over the operating range and properly adjusting the spring bias torque. The counterbalancing dynamics may also be adapted by combining springs with different mechanical properties in parallel or in series. An advantage of using a belt instead of cable is that it has no spring back as compared to a steel cable which makes it easier to set up for transportation and installation.

Rotation of the sprocket 136 to move the platform 120 up and down is accomplished through a rotation generation and transmission assembly comprising transfer chain 140 connecting the larger sprocket 136 to a smaller sprocket 137 at the output of gearbox 141 in turn rotated by a crank or ratcheting winding handle 142. Alternatively, the chain 140 can be driven by a low power gear-motor assembly connectable to a dwelling standard wall electrical power outlet.

Most parts of the platform elevator 100 are made of aluminum to minimize the weight of the apparatus and make it easily transportable. The legs and the platform 120 can easily be removed and assembled on the opposite side of the upright members to place the winding handle 142 on the desired side of the elevator 100 to provide flexibility for the positioning of the elevator in a room. The simple cantilever structure of the elevator 100 helps reducing the weight and cost of the apparatus and further improves accessibility to the supporting surface while limiting potential interaction of the stored goods with the elevator structure. The supporting surface 121 may comprise a grid top material to further reduce weight, may be supported by a generally open frame and be removable. The horizontal portion of the platform 120 may further be articulated with respect to the runners 122, 123 to enable upward flipping of that portion to make the elevator 100 even more compact for shipping or moving.

In operation, a user may load a small vehicle by driving over the low profile platform 120 from a lower position and rotate the handle 142 to lift the platform and the vehicle to the desired storage height. The effort required is minimized thanks to the counterbalancing torque provided by the elongated coil spring 135 arranged to rotate the shaft 132 in the lifting (winding) direction and to the tackle assembly reducing the torque applied to the shaft by the hoisted load. An empty platform can be lifted with no effort at least over the first segment of the path.

The floor area under the platform 120 then becomes free and available for storing another vehicle or other material. When use of the overhead stored vehicle becomes required, the user merely has to clear the space underneath the platform 120 and rotate the handle 142 in the opposite direction to lower the platform to the ground and use the vehicle. Removing the supporting surface 121 or using an open type of supporting surface may enable a user to access lower parts of a supported light vehicle to perform repair or maintenance tasks.

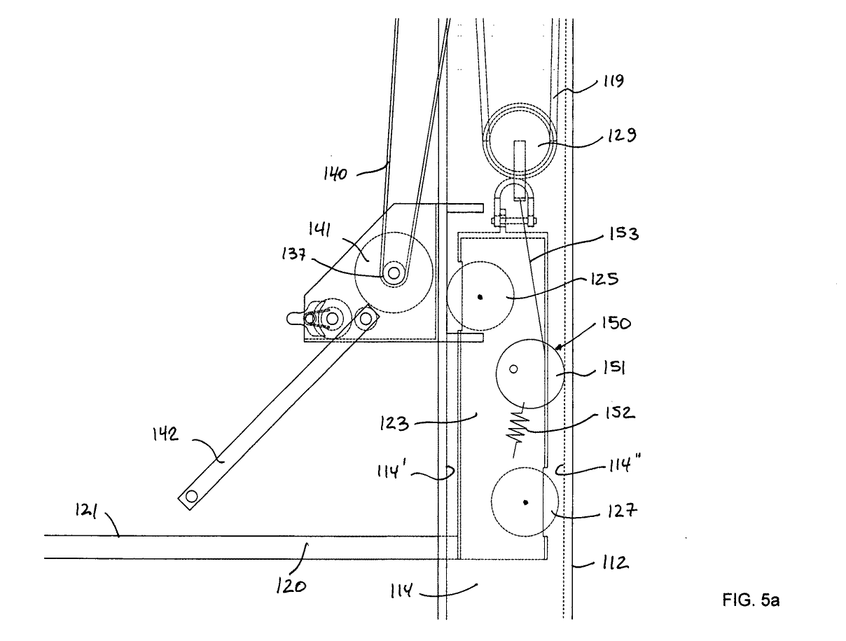

Use of a ratcheting crank provides a fair level of safety to prevent accidental descent of the platform during operation or storage. However, a safety brake device as illustrated in FIG. 5 may further be provided to prevent movement of the platform should the tension force in cable or belt 118 or 119 become lower than a predetermined value.

The safety brake 150 interposed between a runner such as 123 and a rail such as 114″ comprises an eccentric cam 151 rotatably assembled on the runner 123 and urged against rail 114″ by a small coil spring 152 assembled between the cam and the runner. The upper portion of the cam 151 is connected to a portion of the tackle (cable 119 or pulley assembly 129) through a link 153 so that when there is a normal tension in cable 119, the cam 151 is pulled upwards in a retracted position clearing rail 114″. Therefore, should the tension in the cable become insufficient to properly support the platform 120, the cam is automatically urged against the rail causing immediate braking. The more load is applied to the runner 123 the more compression is applied between the eccentric cam 151 and the rail 111′ to increase friction and prevent descent of the platform 120.

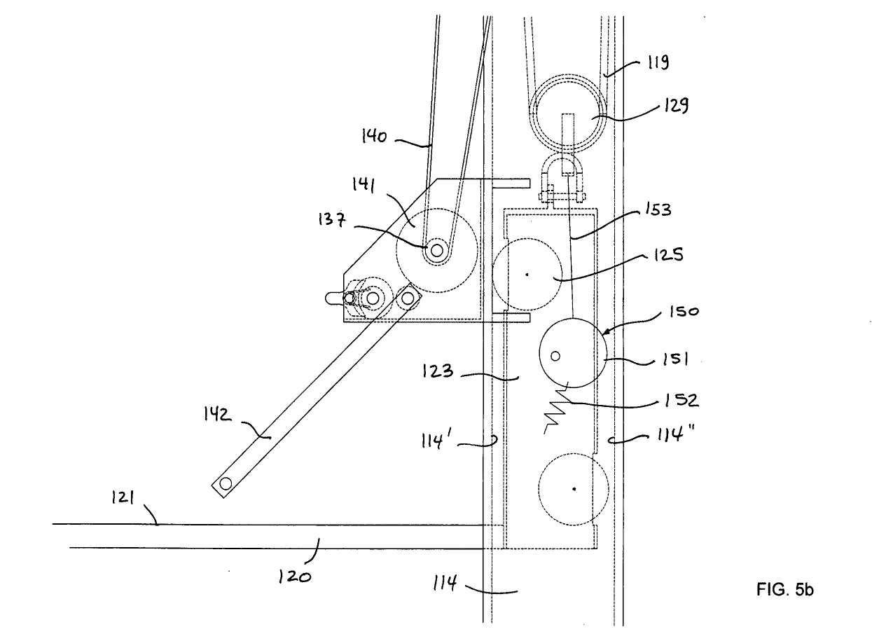

FIGS. 6a to 6c show a further embodiment of the platform elevator 100 implementing a preferred alternate platform hoisting assembly based on a chain drive mechanism.

In this embodiment, winding devices 133 and 134 mounted on shaft 132, instead of comprising hubs, spools or drums to wind cables or belts thereon, rather comprise chain sprockets 633 and 634 located at each end of the shaft in vertical alignment with the rails of upright members 111, 112. Sprockets 633, 634 have a smaller diameter than drive sprocket 136 to present some speed reduction of about 1:1.5 reducing the pulling effort required at a continuous loop hand pulled drive chain 640 engaged on sprocket 136 to enable rotation of shaft 132 and operation of the hoisting assembly.

A second set of chain loops 651 and 652 is engaged and driven by sprockets 633 and 634 respectively. The lower end of chain loop 651 is engaged on the input drive sprocket 661 of a special chain block 660 fixedly mounted to the upright 111 in track 113. Symmetrically, the lower end of chain loop 652 is engaged on the input drive sprocket 671 of the special chain block 670 mounted to the upright 112 in track 114. Each chain block 660, 670 further comprises an output sprocket 662, 672 driven through speed reducing gearing inside the chain blocks and in turn driving lift chains (hoisting members) 618 and 619 respectively connected to the top of runners 122, 123 through hooks 668 and 669. Standard chain blocks, such as the % Ton hand pulled model manufactured by Vulcan Hoist Co. Ltd, can be modified to be so assembled instead of being suspended by the standard hook provided as standard. Thereby, a convenient and cost effective solution is provided to implement a high speed reduction ratio of about 1:36 in the hoisting mechanism, enabling lifting a 1000 pound load using a human pulling force of less than 30 pounds at the shaft's pull chain.

Other benefits of this latter embodiment include the perfect symmetry provided on both sides of the platform, preventing any possible difference in height (diameter) as may happen with cable windings spools in hubs or drums 133 and 134, which could cause unbalance and/or jamming of the platform 120 being lifted. In addition, the standard chain blocks implement safety brakes enabling safe operation of the hoisting mechanism without additional safety devices.

It can thus be easily appreciated that the above-described non-restrictive illustrative embodiments of the platform elevator according to the present invention obviate the above-discussed limitations and drawbacks of the existing apparatuses and systems. More specifically, the platform elevator provides a compact, light weight and low cost means for storing small vehicle above ground in order to free storage space underneath. Furthermore, the contemplated hoisting mechanisms are simple, reliable and can be operated manually with little effort.

Although the present invention has been described hereinabove by way of non-restrictive, illustrative embodiments thereof, these embodiments can be modified at will within the scope of the appended claims without departing from the spirit and nature of the subject invention.

What is claimed is:

1. A platform elevator comprising i) an upright frame having first and second elongated upright members provided with a longitudinal track and an elongated generally orthogonal leg at their lower end, and connected to each other at an upper end thereof by an elongated hoisting box having an axial rotatable shaft for driving first and second hoisting assemblies having respectively a first and a second slender hoisting member extending from a lower end thereof and vertically movable in response to rotation of the shaft, and ii) a cantilever platform connected to the hoisting members and comprising a generally horizontal supporting surface and first and second lateral upright runners adapted to snugly glide in respective first and second tracks of the upright members, whereby, rotation of the shaft causes the platform to be upwardly or downwardly translated while being guided by the runners traveling in the tracks.

2. A platform elevator according to claim 1, wherein the first hoisting member is connected to a top portion of the first runner and the second hoisting member is connected to a top portion of the second runner.

3. A platform elevator according to claim 1, wherein said first hoisting assembly comprises a first winding hub mounted to a first end portion of the shaft and said second hoisting assembly comprises a second winding hub mounted to a second end portion of the shaft, first and second winding hubs being synchronously rotatable through shaft rotation.

4. A platform elevator according to claim 3, wherein each hoisting member comprises a cable.

5. A platform elevator according to claim 3, wherein each hoisting member comprises a flat belt.

6. A platform elevator according to claim 3, wherein the hoisting box further comprises a compensating coil spring assembled to the shaft for partly counterbalancing platform weight and a load supported thereby.

7. A platform elevator according to claim 1, wherein each track defines first and second axial rails and each runner defines a first roller projecting from a first side of the runner to travel on the first rail and a second roller vertically spaced from the first roller, projecting from a second opposite side of the runner to travel on the second rail, so that opposite horizontal reaction forces proportional to the vertical spacing between the rollers are applied on said first and second rails to counterbalance a torque created by the cantilever platform and a load supported thereon, thus maintaining said platform in a stable horizontal attitude in any vertical position.

8. A platform elevator according to claim 1, wherein said first hoisting assembly comprises a first chain sprocket mounted to a first end portion of the shaft and said second hoisting assembly comprises a second chain sprocket mounted to a second end portion of the shaft, first and second sprockets being synchronously drivable through shaft rotation.

9. A platform elevator according to claim 8, wherein each hoisting member comprises at least one chain.

10. A platform elevator according to claim 9, wherein i) the first hoisting assembly comprises a chain block having a housing rigidly mounted to said first upright member, an input sprocket driven by said shaft through said first sprocket and an endless chain, and an output sprocket driving one of the at least one hoisting member extending from said first hoisting assembly and connected to a first end of the cantilever platform and, ii) the second hoisting assembly comprises a chain block having a housing rigidly mounted to said second upright member, an input sprocket driven by the shaft through said second sprocket and an endless chain, and an output sprocket driving one of the at least one hoisting member extending from said second hoisting assembly and connected to a second end of the cantilever platform.

11. A platform elevator according to claim 10, wherein each chain block further comprises internal gearing providing speed reduction between the output sprocket and the input sprocket so that a load generating a torque on said output sprocket can be counterbalanced by a lower torque applied to the shaft.

12. A platform elevator according to claim 10, wherein each chain block further comprises an internal braking device for maintaining the vertical position of the cantilever platform while no torque is applied to the shaft.

13. A platform elevator according to claim 1, further comprising a sprocket mounted at an end of the shaft projecting out of the hoisting box and an endless chain having an end engaged on said sprocket so that a pulling force applied to said chain imparts rotation of the shaft.

14. A platform elevator according to claim 13, wherein the endless chain has a second end engaged on a sprocket of a crank device mounted to one of the upright members.

15. A platform elevator according to claim 10, wherein the endless chain has a second end engaged on a sprocket drivable by a motorized device mounted to one of the upright members.

16. A platform elevator comprising
an upright frame having first and second elongated upright members provided with a longitudinal track and an elongated generally orthogonal leg at their lower end, and connected to each other at an upper end thereof by an elongated hoisting box having an axial rotatable shaft for driving first and second hoisting assemblies having respectively a first and a second hoisting chain extending from a lower end thereof and vertically movable in response to rotation of the shaft, and
a cantilever platform comprising a generally horizontal supporting surface, a first lateral upright runner adapted to snugly glide in the track of the first upright member and having a top portion connected to the first hoisting chain and a second lateral upright runner adapted to snugly glide in the track of the second upright member and having a top portion connected to the second hoisting chain,
said first hoisting assembly comprising a first chain sprocket mounted to a first end portion of the shaft, and a chain block having a housing rigidly mounted to said first upright member, an input sprocket driven by said shaft through said first sprocket and an endless chain, and an output sprocket driving the first hoisting chain,
said second hoisting assembly comprising a second chain sprocket mounted to a second end portion of the shaft, and a chain block having a housing rigidly mounted to said second upright member, an input sprocket driven by the shaft through said second sprocket and an endless chain, and an output sprocket driving the second hoisting chain,
whereby, rotation of the shaft causes the first and second sprockets thereon to be synchronously driven, in turn causing the cantilever platform to be upwardly or downwardly translated accordingly while being guided by the runners traveling in the tracks.

17. A platform elevator comprising
an upright frame having first and second elongated upright members provided with a longitudinal track and an elongated generally orthogonal leg at their lower end, and connected to each other at an upper end thereof by an elongated hoisting box comprising an axial rotatable shaft having a first belt winding hub mounted to a first end portion thereof for driving a first hoisting belt, and a second belt winding hub mounted to a second end portion thereof for driving a second hoisting belt, and
a cantilever platform comprising a generally horizontal supporting surface, a first lateral upright runner adapted to snugly glide in the track of the first upright member and having a top portion comprising a pulley for engaging the first hoisting belt and a second lateral upright runner adapted to snugly glide in the track of the second upright member and having a top portion comprising a pulley for engaging the second hoisting belt,
and shaft rotating means,
whereby, rotation of the shaft causes the first and second winding hubs thereon to be synchronously driven, in turn causing the belts to be winded and the cantilever platform to be upwardly or downwardly translated accordingly while being guided by the runners traveling in the tracks.
